(19) United States
(12) Patent Application Publication
(10) Pub. No.: US 2023/0396210 A1
(43) Pub. Date: Dec. 7, 2023

(54) PONY MODULE FOR SOLAR TRACKER

(71) Applicant: NEVADOS ENGINEERING, INC., SAN FRANCISCO, CA (US)

(72) Inventors: Yezin TAHA, San Francisco, CA (US); Amitoj GILL, Roseville, CA (US); Laura SVERCHEK, San Francisco, CA (US); Anthony HELM, Martinez, CA (US)

(73) Assignee: NEVADOS ENGINEERING, INC., SAN FRANCISCO, CA (US)

(21) Appl. No.: 18/205,948

(22) Filed: Jun. 5, 2023

Related U.S. Application Data
(60) Provisional application No. 63/349,447, filed on Jun. 6, 2022.
(60) Provisional application No. 63/423,921, filed on Nov. 9, 2022.

(51) Int. Cl. H02S 20/32; F24S 30/425

(52) U.S. Cl. CPC H02S 20/32; F24S 30/425; F24S 2030/12

(57) ABSTRACT

A pony module having a solar panel may power a controller and/or drive device in a solar tracker. The pony module may be mounted directly on the drive device or a cradle supporting a solar panel support (e.g., a torque tube) attached to the drive device. The controller may be mounted on the solar panel of the pony module or may be mounted on the torque tube itself.

### CROSS REFERENCE TO RELATED APPLICATIONS

The application claims priority to U.S. Provisional Patent Application 63/349,447 titled “PONY MODULE FOR SOLAR TRACKER” filed on Jun. 6, 2022 and U.S. Provisional Patent Application 63/423,921 titled “PONY MODULE FOR SOLAR TRACKER” filed on Nov. 9, 2022. All of the above-mentioned applications are incorporated herein by reference in their entirety.

### FIELD OF THE INVENTION

The invention relates generally to solar trackers, specifically pony modules that power controllers in solar trackers.

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to partially track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

The solar panels themselves may be disposed on solar panel supports such as torque tubes. In order to rotate the panels, a drive device such as a slew drive may be coupled to the torque tubes and drive rotation. The drive device may be connected to a controller that directs the drive device when to rotate, and at what angle. Both the drive device and controller need to be powered.

### SUMMARY

Embodiments of this invention include a solar tracker or parts of a solar tracker, including a pony module including a solar panel powering a controller and/or a drive device. The pony module may be mounted directly on the drive device or may be mounted directly on torque tube cradles coupled to the drive device. The controller may be mounted on torque tubes supported by the torque tube cradles or mounted directly on the solar panel of the pony module.

Embodiments of the invention may include a solar tracker, including: a pony module, including: a solar panel, and a plurality of brackets attached to the solar panel, and a plurality of support couplers directly attached to the brackets of the pony module; at least one solar panel module support arranged in the support couplers and configured to support a solar panel module, a drive device directly attached to the support couplers and configured to rotate the at least one solar panel module support and the pony module, a controller directly attached to the at least one solar panel module support, and wherein the solar panel of the pony module is configured to power the controller.

The solar tracker may have wherein the solar panel is configured to power the drive device.

The solar tracker may have wherein the drive device is disposed on a base directly attached to a support post.

The solar tracker may further include a plurality of solar panel modules disposed on the at least one solar panel module support, and wherein the solar panel of the pony module is on a parallel plane with planes of the solar panel modules.

The solar tracker may have wherein the support couplers are each a cradle comprising wings angled at a non-perpendicular angle to a surface of the drive device attached to the cradle, the brackets comprise a surface attached to the wings parallel to a plane of the wings.

The solar tracker may have wherein the plurality of support couplers comprise two support couplers on opposing sides of the drive device, and the plurality of brackets comprise two brackets directly attached to the two support couplers, respectively.

The solar tracker may have wherein the pony module is not in direct contact with the drive device.

Embodiments of the invention may include solar tracker, including: a pony module, including: a solar panel, and a plurality of brackets attached to the solar panel, and a drive device directly attached to the brackets of the pony module, a plurality of support couplers coupled to the drive device, at least one solar panel module support arranged in the support couplers and configured to support a solar panel module, a controller directly attached to the at least one solar panel module support, and wherein the solar panel of the pony module is configured to power the controller and the drive device is configured to rotate the at least one solar panel module support and the pony module.

The solar tracker may have wherein the solar panel is configured to power the drive device.

The solar tracker may have wherein the drive device is on a base directly attached to a support post.

The solar tracker may further include a plurality of solar panel modules on the at least one solar panel module support, wherein the solar panel of the pony module is on a parallel plane with planes of the solar panel modules.

The solar tracker may have wherein one of the brackets comprises a plate with first holes, the support coupler comprises second holes aligned with the first holes, the drive device includes third holes aligned with the first holes and the second holes, and a plurality of fasteners being arranged through the first holes, the second holes, and the third holes.

The solar tracker may have wherein the brackets are spaced apart from each other at a distance lesser than a width of the drive device, the width taken in a direction perpendicular to a surface of the drive device attached with one of the brackets.

The solar tracker may further include a plurality of solar panel modules disposed on the at least one solar panel module support, wherein the solar panel of the pony module has a smaller area than each of the solar panel modules.

Embodiments of the invention may include a solar panel assembly, including: a pony module, including: a solar panel, a controller directly attached to the solar panel, and a plurality of brackets attached to the solar panel, and a drive device directly attached to the brackets of the pony module, and a plurality of support couplers coupled to the drive device and configured to couple at least one solar panel module support to the drive device, and wherein the solar panel of the pony module is configured to power the controller and the drive device is configured to rotate the at least one solar panel module support and the pony module.

The solar tracker may have wherein the solar panel powers the drive device.

The solar tracker may further include a plurality of solar panel modules on the at least one solar panel module support, and the solar panel of the pony module is on a parallel plane with planes of the solar panel modules.

The solar tracker may have wherein one of the brackets comprises a plate with first holes, the support coupler comprises second holes aligned with the first holes, the drive device includes third holes aligned with the first holes and the second holes, and a plurality of fasteners being arranged through the first holes, the second holes, and the third holes.

The solar tracker may have wherein the brackets are spaced apart from each other at a distance lesser than a width of the drive device, the width taken in a direction perpendicular to a surface of the drive device attached with one of the brackets.

The solar tracker may further include a plurality of solar panel modules disposed on the at least one solar panel module support, wherein the solar panel of the pony module has a smaller area than each of the solar panel modules.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 shows an example of an all-terrain solar tracker arranged on sloped and rolling terrain with angle changes along its length to follow the natural terrain.

FIG. 2 shows an exploded view of a pony module to be directly attached to cradles on a slew drive and slew drive base.

FIG. 3 shows a pony module directly attached to cradles on a slew drive and slew drive base.

FIG. 4 shows an underside plan view of a pony module directly attached to cradles supporting a torque tube, with a controller attached to the torque tube.

FIG. 5 shows an exploded view of a pony module to be directly attached to a slew drive.

FIG. 6 shows a pony module directly attached to a slew drive.

FIGS. 7a and 7b show an exploded view and underside plan view of a controller attached to a solar panel of the pony module.

FIGS. 8a and 8b show, respectively an underside plan view and a perspective view of a pony module attached directly to a slew drive on a slew drive base, and a controller attached to a torque tube extending from cradles attached to the slew drive.

FIGS. 9a and 9b show an exploded and non-exploded view of a controller attached to a torque tube.

FIGS. 10a and 10b show an overhead plan view and a perspective view of a pony module in a solar tracker, between solar panel modules carried by torque tubes in the solar tracker.

FIGS. 11a and 11b show a side view slew drives with their immediately adjacent solar panel support and bearing assembly. FIG. 11a shows a concentric slew drive, and FIG. 11b shows a slew drive with an offset cradle.

FIG. 12 shows a perspective view of a solar site array with two neighboring trackers and two bays of solar modules each.

FIG. 13 shows a cross section of a single tracker with three bays of solar modules on an upward slope extending along the North-South axis.

FIG. 14 shows a cross section of a solar site array with three trackers neighboring each other along the East-West axis.

FIG. 15 shows a block diagram of a solar panel control system in communication with a solar panel array.

FIG. 16 shows a block diagram illustrating components of a machine able to read instructions from a machine-readable medium and perform any one or more of the methodologies discussed below.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical”.

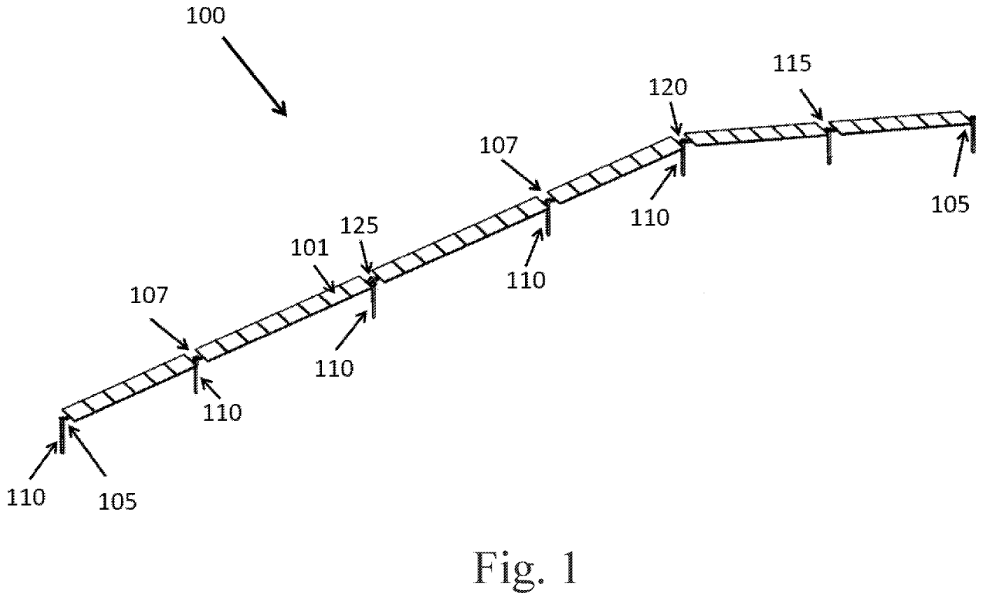

FIG. 1 shows an example of an individual all-terrain solar tracker (such as included in the solar array site described above) arranged on varying terrain with angle changes along its length to follow the natural terrain. This tracker employs examples of many of the components that may or may not be present in a tracker. These components include articulated bearings supporting significant changes in angular orientation between adjacent segments of the torque tube, flexure bearings supporting smaller changes in angular orientation between adjacent segments of the torque tube without requiring an articulated bearing, straight through bearings, mechanical stops limiting rotation of the tracker, and a row end bearing. The tracker in addition includes a slew drive configured to drive rotation of the torque tube around its long axes. Although the example of FIG. 1 and other figures shows a particular arrangement of certain components, other variations may employ any suitable combination and arrangement of the components described in this disclosure. Some elements illustrated in certain figures may be unlabeled in those figures and only be labelled in other figures, for convenience and clarity of illustration and to avoid repetition.

The variable terrain and single axis solar tracker 100 of FIG. 1 employs support posts 110, solar panel module supports 104 such as torque tubes extending between the support posts, and solar panel modules 101 supported by the torque tubes. Multiple solar panel modules may be between each of the support posts, and they may all be of a same size as one another, or some of them may be different sizes from each other. The solar panel modules may each comprise a solar module frame which supports the solar cells in the panels. The number of solar panel modules between each of the support posts may be the same along the tracker, or it may vary depending on the terrain and the spacing of specific support posts.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of assemblies may be disposed on top of support posts, depending on the terrain and the position of the support post with relation to the rest of the trackers: straight-through bearing assemblies 107 for sloping planar surfaces, flat land bearing assembly 115 for flat land, row end bearing assembly 105 for an end of a the tracker, articulating joint bearing assembly 120 for changing terrain angles, and slew drive assembly 125 at an end of the tracker or an intermediate position along the tracker in order to drive rotation of the tracker.

For example, opposite ends of the tracker are rotationally supported by row end bearing assemblies 105 on support posts 110. The portion of the tracker arranged on the slope is supported by straight-through bearing assemblies 107, which include thrust bearings that isolate and transmit portions of the slope load to corresponding support posts 110. The portion of the tracker arranged on flat land, above the slope, is rotationally supported by a flat land bearing assembly 115 which may be a conventional pass-through bearing assembly lacking thrust bearings as described above. The slew drive assembly may drive rotation of the solar panel modules 101 about the first and second rotation axes to track the sun. The solar panel modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 120 links the two non-collinear rotation axes and transmits torque between them. Example configurations for bearing assemblies 105, 107 and 120 are described in more detail below.

Other variations of the variable terrain solar tracker 100 may include other combinations of bearing assemblies 105, 107, 115, and 120 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

As noted above articulating joint bearing assembly 120 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke ears from the first shaft into the yoke ears of the second shaft.

A solar panel array control system may be provided, which may control operation of one or more solar panels in the solar array. Operation of the one or more solar panels may include positioning of the one or more solar panels. For example, the solar panel array control system may control an orientation of one or more solar panels. The control system may send signals to a solar panel supporting structure, which may affect the position of the one or more solar panels. The articulating joint may be capable of allowing a position of a solar panel to be controlled from the control system.

The solar panel support structure affecting position of the one or more solar panels may include a slew drive and a controller directing the slew drive. The slew drive and/or the controller need to be powered.

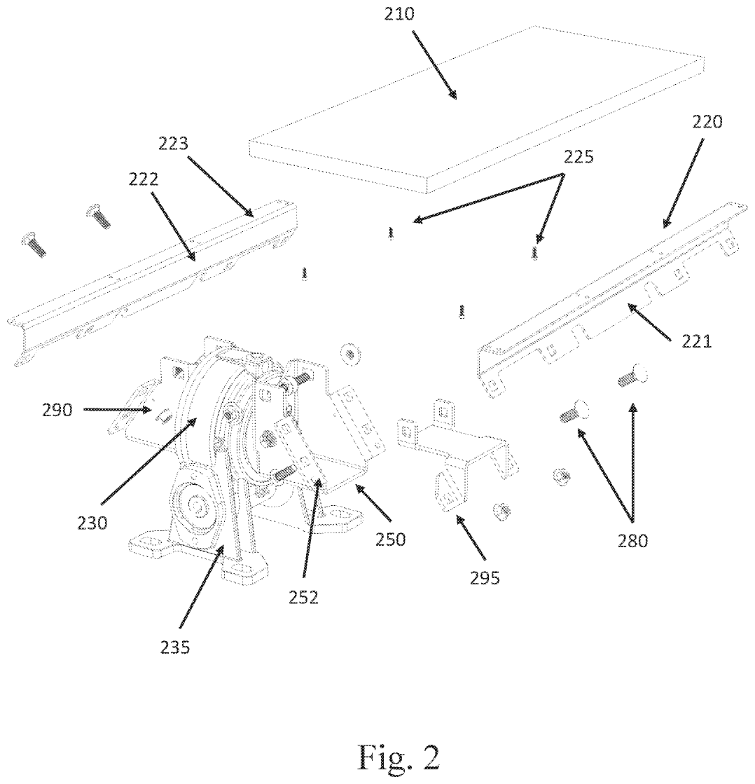

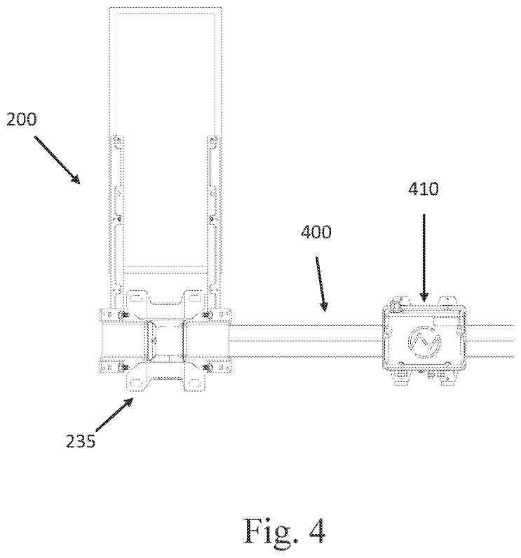

FIG. 2 illustrates an exploded view of the pony module, and the slew drive assembly 125 that it is coupled to. The pony module 200 includes at least a solar panel 210 and brackets 220. The solar panel 210 may power a controller 410 and/or a slew drive 230 of the solar tracker. That is, the solar panel 210 may charge a battery in the controller 410, run the electronics in the controller 410 without the need for battery power, and/or augment the battery power supply when the slew drive 230 is in operation. If the controller 410 has a battery chargeable by the solar panel 210, that battery may also power the slew drive 230. Additionally, if the solar panel 210 is big enough, it can operate the slew drive 230 without the need for a battery. The brackets 220 may be attached to the solar panel 210 by a plurality of fasteners 225, e.g. four fasteners 225. The pony module 200 is attached or coupled to a slew drive assembly 125, e.g., a slew drive 230 on a slew drive base 235 with cradles 250, supported by a support post 110. The slew drive base 235 and the slew drive 230 may be integral to each other to be all one piece, or they may be separate components attached together. The pony module 200 may be directly attached to the cradles 250 such that they are not in direct contact with the slew drive 230. The attachment of the bracket 220 to the cradles 250 may be done by fasteners 280, 290 that fasten the bracket 220 to each of the cradles 250 at the wings 252 of the cradles 250. The wings 252 may project outward from each other at a sloped portion of the cradle. There may be two fasteners 280 and two fasteners 290 for each of the brackets 220, e.g. four fasteners 280 and four fasteners 290 total. The fasteners 225, 280, and 290 may each be or comprise any of screws, bolts, nuts, washers, etc. The slew drive 230 may have a width in a first direction (e.g., the North-South direction) perpendicular to a second direction in which a length of the brackets 220 extend (e.g., the East-West direction). The brackets 220 may be spaced apart at a distance greater than a width of the slew drive 230 and may each be fastened at an edge of the solar panel 210, as shown in FIG. 4. Since the cradles 250 may be directly attached on opposing surfaces of the slew drive 230, the brackets 220 may be attached on opposing sides of the slew drive 230.

The solar panel 210 may be a bifacial solar panel 210. A bifacial solar panel is able to absorb light from a front surface as well as a back surface opposite the front surface, and convert light from both sides into energy. Because of this capability, the bifacial solar panel 210 may simultaneously collect direct sunlight and/or any light coming from above the tracker, while absorbing light reflected from the ground under or around the tracker. This increases the solar generation capacity, allowing the battery to be charged during diffuse sunlight events such as overcast. Additionally, the battery in the controller 410 may also be charged at a faster rate under challenging weather conditions. With the battery more available to be readily charged by the bifacial solar panel 210, the tracker can operate longer.

The pony module 200 may include two brackets 220 each attached to one of the cradles 250. The brackets 220 may have a panel attachment surface 223 in direct contact with the solar panel 210, a connecting surface 222 perpendicular to the attachment surface 223, and a cradle attachment surface 221 in direct contact to one of the cradles 250 when fastened. The cradle attachment surface 221 may be angled with respect to the connecting surface 222 at a non-perpendicular angle, e.g. an obtuse angle. When the bracket 220 is fastened, the wings 252 of the cradle 250 may be at a same angle with relation to the connecting surface 222 of the bracket 220 as the cradle attachment surface 221. In other words, the cradle attachment surface 221 may be angled against the connecting surface 222 to extend parallel to the wings 252.

The brackets 220 may be attached to the different parts of the cradle 250 other than the wings 252. For example, the brackets 220 may be attached to a non-angled part of the cradle. In this case, the brackets 220 may have an attachment surface that is perpendicular to the connecting surface 222 or parallel to panel attachment surface 223. For example, the brackets 220 may be attached to a flat bottom surface of the cradle, or may be attached to a top region of the cradle, among other like regions and surfaces.

The cradles 250 are used to support solar panel module supports, e.g. torque tubes. An end of the torque tube sits in the cradle 250 and a cradle clamp 295 may be secured over the cradle 250 and the torque tube and secured with fasteners to further secure the torque tube in the cradle 250.

In operation, the slew drive 230 may drive rotation of the torque tubes. The slew drive 230 may drive rotation of the torque tubes via the cradles 250. Since the cradles 250 are rotated by the slew drive 230, the pony module 200 attached to the cradles may rotate along with the slew drive 230. Whenever the slew drive 230 rotates the solar panel modules 101 supported by the torque tube, the pony module 200 (and the solar panel 210) may be rotated the same angle. In this way, shading of the solar panel 210 by the solar panel modules 101 on the torque tubes is avoided.

The slew drive base 235 is mounted and/or coupled to a support post 110, so that the pony module 200 is also supported by the support post 110 via coupling to the slew drive base 235. That is, the slew drive base 235 may be mounted on post mounts that are then directly attached to the support post 110.

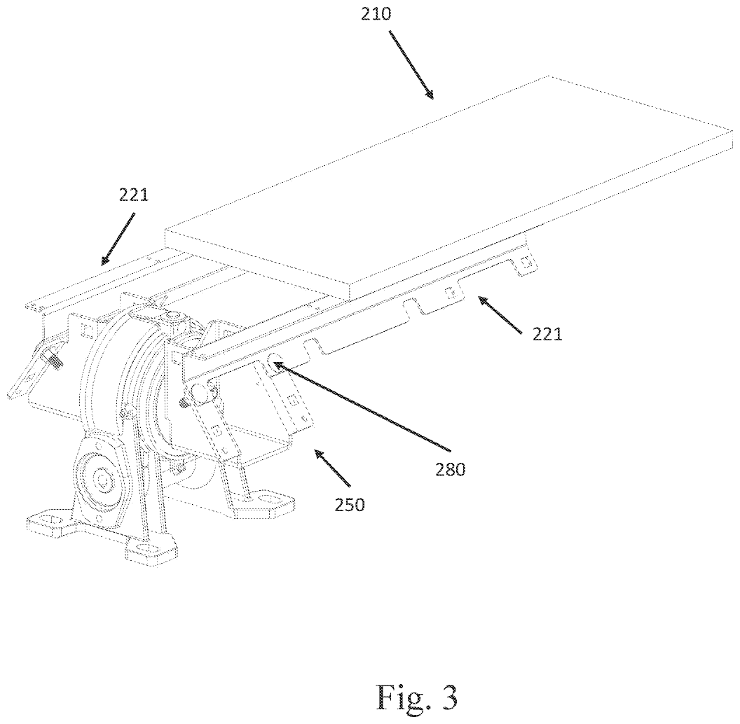

In the non-exploded view, FIG. 3 illustrates the pony module coupled to the slew drive by direct attachment to the cradles. The cradle clamp is not shown here for ease of illustration.

FIG. 4 illustrates an underside view of the pony module 200 coupled to the slew drive 230 by attachment to the cradles, as well as the torque tube 400 secured to one of the cradles and supporting a controller 410. The controller 410 may be a row controller electrically wired to and controlling the slew drive to drive rotation of the torque tubes in the solar tracker and/or providing data to a central controller to allow the central controller to direct rotation of the torque tubes in the tracker row. Alternatively or additionally, the row controller may receive instructions from the central controller and, in turn, direct the slew drive according to the received instructions. Each solar tracker row may have a row controller.

In embodiments of the invention, the controller 410 may be attached to the torque tube 400 and spaced apart from the pony module 200, the slew drive 230, and the slew drive base 235 without directly contacting any of those components. Nevertheless, the controller 410 may be electrically wired to the slew drive 230 and/or the solar panel 210 of the pony module 200, and may be powered by the solar panel 210. The controller 410 may be strapped to the torque tube 400 via straps 420. When the torque tube 400 has not been angled by the slew drive 230 and it is in a neutral position, it may have a top side facing the cradle clamp 295 and a bottom side opposite to the top side. The controller 410 may be strapped to this bottom side. This allows solar panel modules 101 to be disposed on the opposing top side of the torque tube where the controller 410 is located.

The controller 410 may be a computer system. A computer system may include at least one of a processor, memory, non-volatile storage, and an interface. A typical computer system may include at least one or more of the following: a processor, memory, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software may be stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor may make use of hardware registers to store values associated with the software, and local cache that, ideally, serves to speed up execution. A software program may be assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor may transform data into new data using implemented data structures and methods, such as is described with reference to the FIGS. in this paper.

The engines described herein, or the engines through which the systems and devices described herein can be implemented, can be cloud-based engines. A cloud-based engine may be an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Datastores may include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. A data structure may be associated with a particular way of storing and organizing data in a computer so that it can be used efficiently within a given context. Data structures may be based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure may entail writing a set of procedures that create and manipulate instances of that structure. The datastores can optionally be cloud-based datastores. A cloud-based datastore may be a datastore that is compatible with cloud-based computing systems and engines.

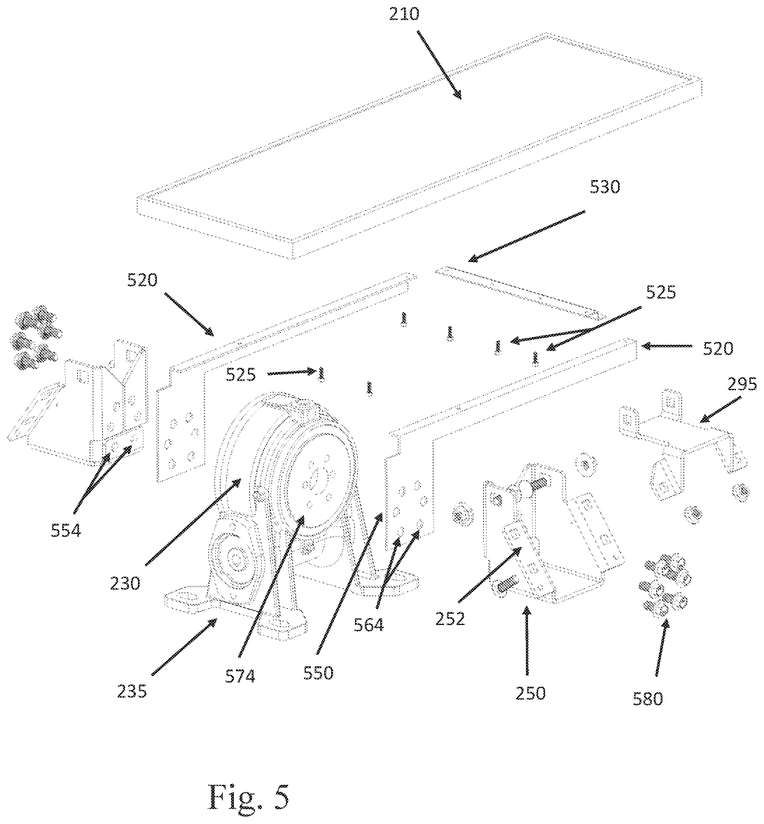

FIG. 5 illustrates an exploded view of the pony module, and the slew drive assembly 125 that it is coupled to. The pony module 200 includes at least a solar panel 210 and brackets 520 and bracket 530. The brackets 520 and bracket 530 may be attached to the solar panel 210 by a plurality of fasteners 225, e.g. six fasteners 525. The pony module 200 is attached or coupled to a slew drive assembly 125. The pony module 200 may be directly attached to the slew drive 230 by the brackets 520 to be in direct contact with the slew drive 230. The brackets 520 may be attached on opposing surfaces of the slew drive 230. The brackets 520 directly attached to the slew drive 230 may also be directly attached to the cradles 250 to be in direct contact with the cradles 250, in that the brackets 520 are each sandwiched by the slew drive 230 and one of the cradles 250. The attachment of the bracket 520 to the slew drive may be done by a plurality of fasteners 580 (e.g., six fasteners 580) that go entirely through holes 554 in the back of the cradle 250, entirely through holes 564 in a plate 550 of the bracket 520, and into holes 574 in the slew drive 230. That is, the slew drive holes 574, the bracket plate holes 564, and the cradles holes 554 may all comprise the same number of holes (e.g., four to eight holes, such as six holes) all be arranged in a same shape (e.g., a hexagon) so that they are aligned with each other. This alignment allows easy fastening of the slew drive 230, the cradle 250, and the bracket 520 to each other. Even if the fasteners 580 go through the back of the cradles 250 and the cradles 250 are directly in contact with the plates 550, the fasteners 580 may screw into or otherwise be secured into the slew drive 230 so that it can be said the plates 550 are fastened to the slew drive 230. The plates 550 of the brackets 520 are angled to rather than being parallel with the wings 252 of the cradles 250. The plates 550 may be parallel to a back of the cradle having the holes 554 and parallel to a surface of the slew drive 230 having the holes 574.

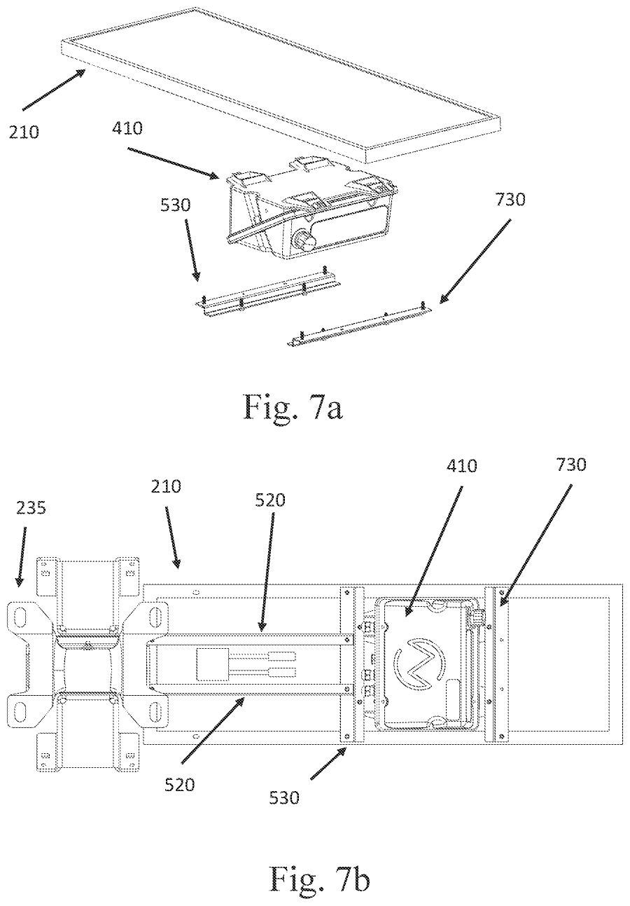

The slew drive 230 may have a width in a first direction (e.g., the North-South direction) perpendicular to a second direction in which a length of the brackets 220 extend (e.g., the East-West direction). The brackets 520 may be spaced apart from each other at a distance equal to or lesser than a width of the slew drive 230. The brackets 520 may each be fastened to be spaced apart farther from longitudinal edges of the solar panel 210 and closer to a center line of the solar panel 210, as shown in FIG. 7b. The bracket 530 may be perpendicular to the brackets 520 as shown in FIG. 5b, and may extend from one longitudinal edge of the solar panel 210 to another.

When the slew drive 230 rotates the cradles 250 and the solar panel modules 101 disposed on the torque tubes 400 secured in the cradles 250, the slew drive 230 also rotates the bracket 520 directly attached to the cradle 230. In this way the solar panel 210 rotates at a same or similar angle to the solar panel modules 101 as the slew drive 230 is driven. In embodiments of the invention, the solar panel 210 is on a plane parallel with the solar panel modules 101, or on a same plane as the solar panel modules 101.

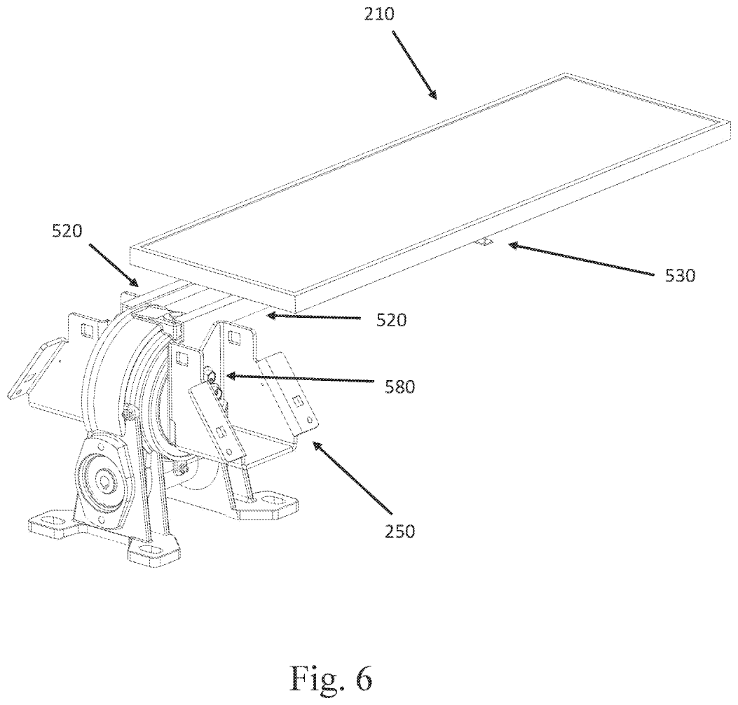

In the non-exploded view, FIG. 6 illustrates the pony module directly attached to the slew drive. The cradle clamp is not shown here for ease of illustration.

FIGS. 7a and 7b illustrate views of the controller 410 directly attached to be in direct contact with the pony module 200, specifically in direct contact with the solar panel 210. The controller 410 may be directly attached with bracket 530 of the pony module, plus another bracket 730 which is parallel with bracket 530 and on the opposing side of the controller 410. The controller 410 may be attached on the underside of the solar panel 210. In this configuration, similar to the configuration when the controller 410 is strapped to the torque tube and spaced apart from the pony module 200, the controller 410 is of course electrically wired to solar panel 210 and/or the slew drive 230.

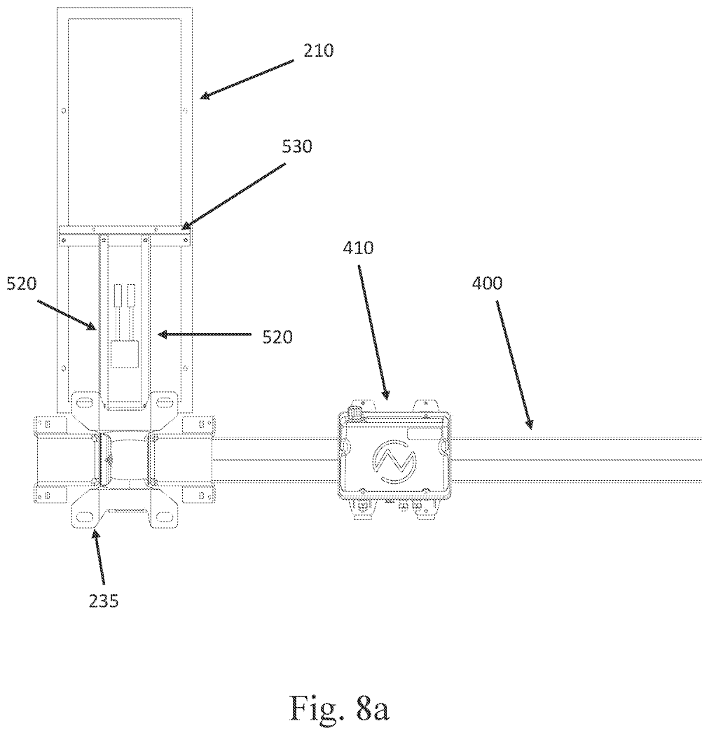

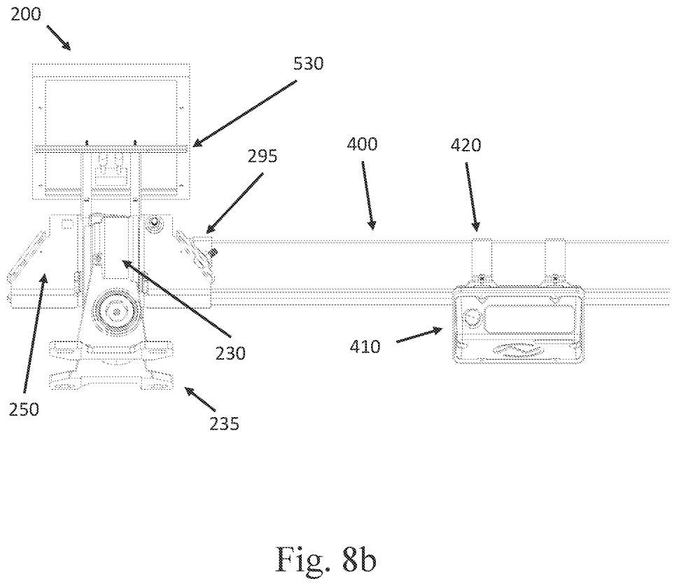

FIGS. 8a and 8b illustrate, respectively, an underside view and a perspective view of the pony module, slew drive assembly, torque tube, and controller. In embodiments of the invention illustrated here, the pony module 200 is directly attached to the slew drive 230 and the controller 410 is spaced apart from the pony module 200 to be directly attached to the torque tube 400.

When the solar panel 210 is bifacial, it may be preferable to use the configuration illustrated in FIG. 4 rather than one illustrated in FIG. 7b or FIG. 8a, which may block some of the light that would have been incident on one the surfaces (the attachment surface directly attached to bracket 530) of the solar panel 210. However, this is not a requirement, as even in those latter embodiments a significant amount of light can be collected and converted to electricity despite any blockage.

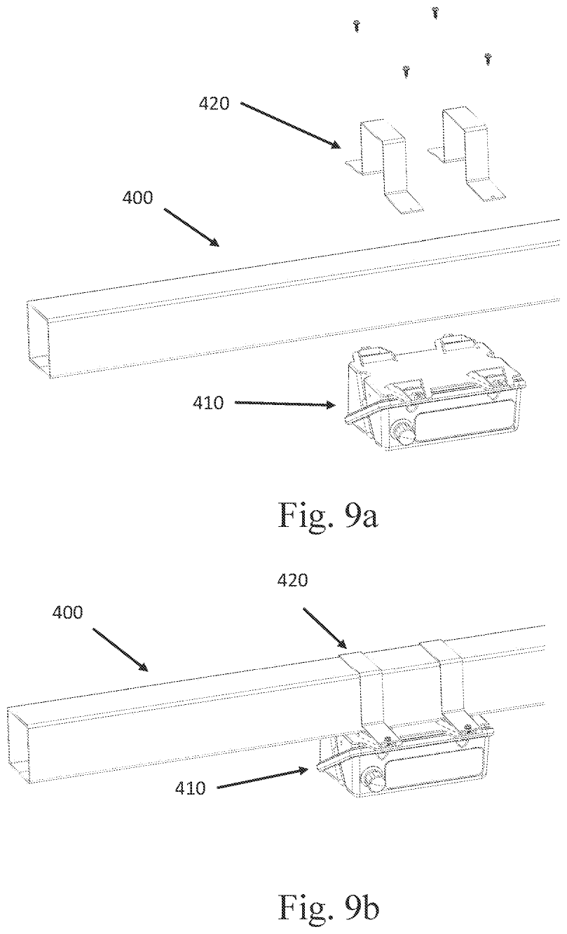

FIGS. 9a and 9b shows how the controller 410 may be directly attached to the torque tube 400 to be spaced apart from the pony module 200 coupled to the slew drive assembly. The controller 410 may be strapped to the torque tube with two straps each 420 having two fasteners. The straps 420 together with a surface of the controller 410 may match a cross-sectional shape of the torque tube 400.

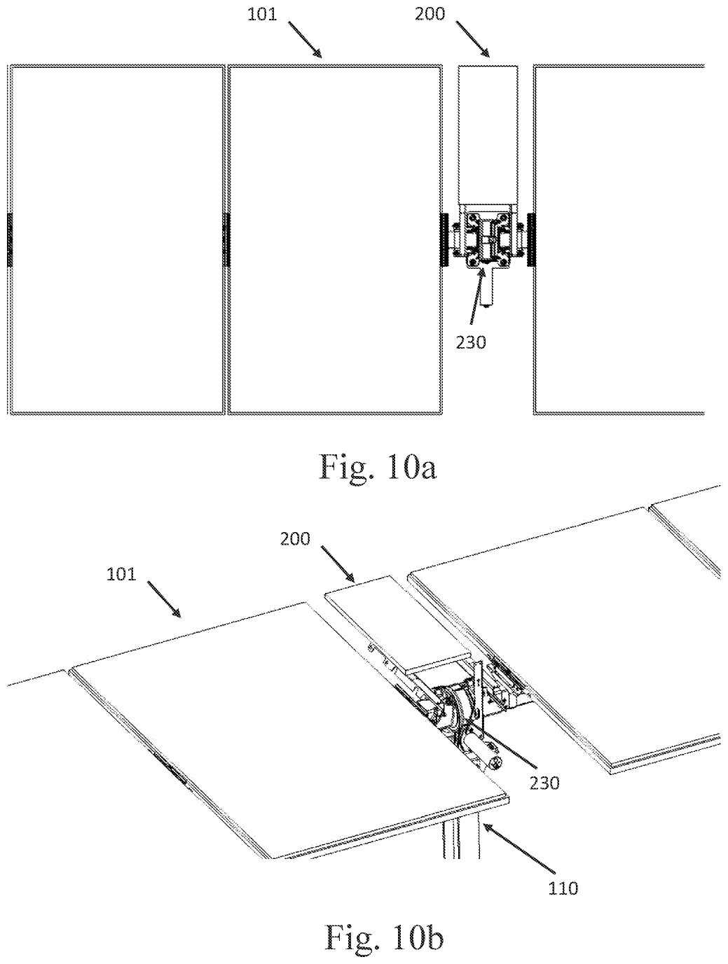

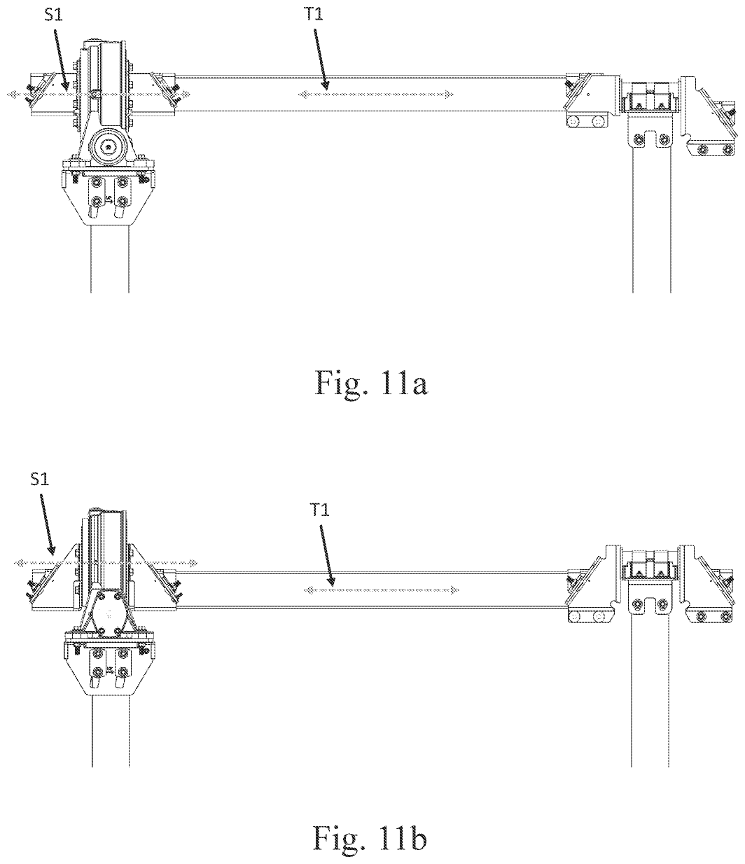

FIGS. 10a and 10b illustrate a solar tracker including the pony module 200 on a slew drive assembly 125 alongside solar panel modules 101, as seen from an overhead view and a perspective view. As can be seen, the solar panel 210 may have a lesser area than the solar panel modules disposed on the torque tubes of the tracker. The solar panel may have less than ½ the length of the solar panel modules (taken in the East-West direction) and/or less than ½ the width of the solar panel modules (taken in the North-South direction). The panel may have a longer length in the East-West direction than a width in the North-South direction, and it may have a rectangular shape and/or a square shape. The total area of the solar panel may be less than ¼ the area of each of the solar panel modules. For example, the solar panel may have dimensions from 2-5 feet by 1-4 feet, such as 3 ft.×2 ft. When the slew drive 230 has the solar panel modules 101 and the solar panel 210 at a tilt angle of 0 degrees (e.g., when they are oriented to be parallel to a horizontal plane and/or in a plane perpendicular to the support post) the solar panel 210 may not cover the slew drive 230. The solar panel 210 may be disposed between two solar panel modules 101 on opposing sides of the slew drive 230.

As shown in FIG. 11A, the slew drive axis S1 of a slew drive 230 may be aligned with the torque tube axis T1 of the of the torque tube 400 immediately adjacent to the slew drive 230. This type of slew drive may be called a concentric slew drive, since it may have one or more cradles 250 whose attachment surface centers align with the center of the concentric slew drive and/or cradles 250 carrying torque tubes whose torque tube axis aligns with the center of the concentric slew drive. The slew drive may have a circular cross section when viewed staring down the axis of the tracker; here, the slew drive center is the center of the circle. This center may also be the slew drive axis S1 around which the slew drive 230 rotates the solar panel supports, solar modules and/or bearing assemblies to which it is coupled to.

Alternatively, as shown in FIG. 11B, a slew drive axis S1 of a slew drive 230 may not be aligned with the torque tube T1 of the torque tube 400 immediately adjacent to the slew drive 300. For example, the slew drive axis S1 may be above the torque tube axis T1. On the other hand, any solar panel modules 101 disposed on that solar panel support 104 and/or subsequent solar panel support down the tracker may have their center of masses aligned with the slew drive axis S1, so that the slew drive 230 may rotate these solar modules around their center of masses.

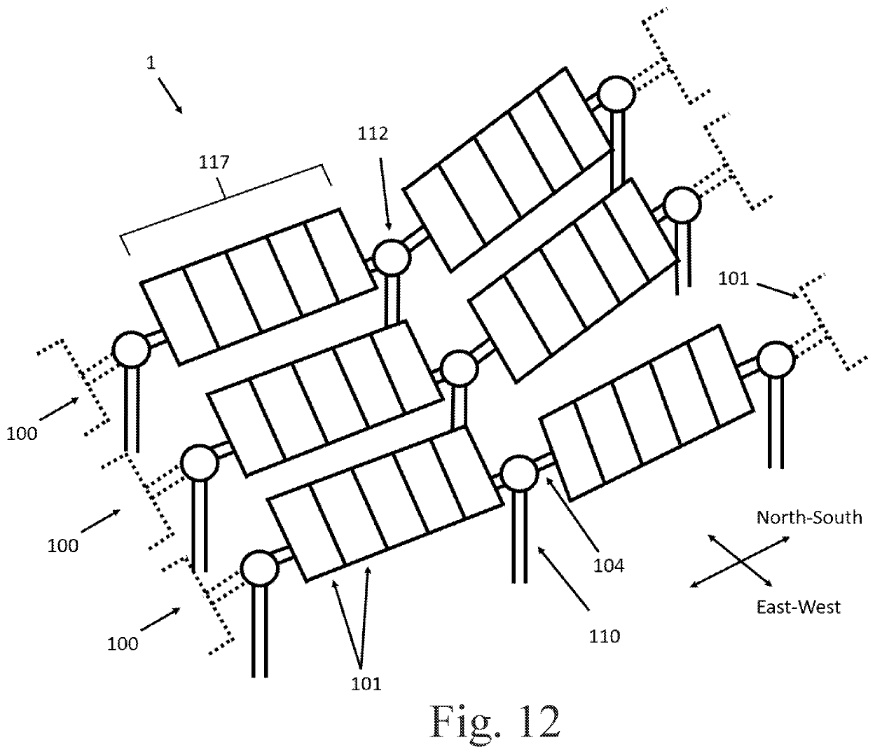

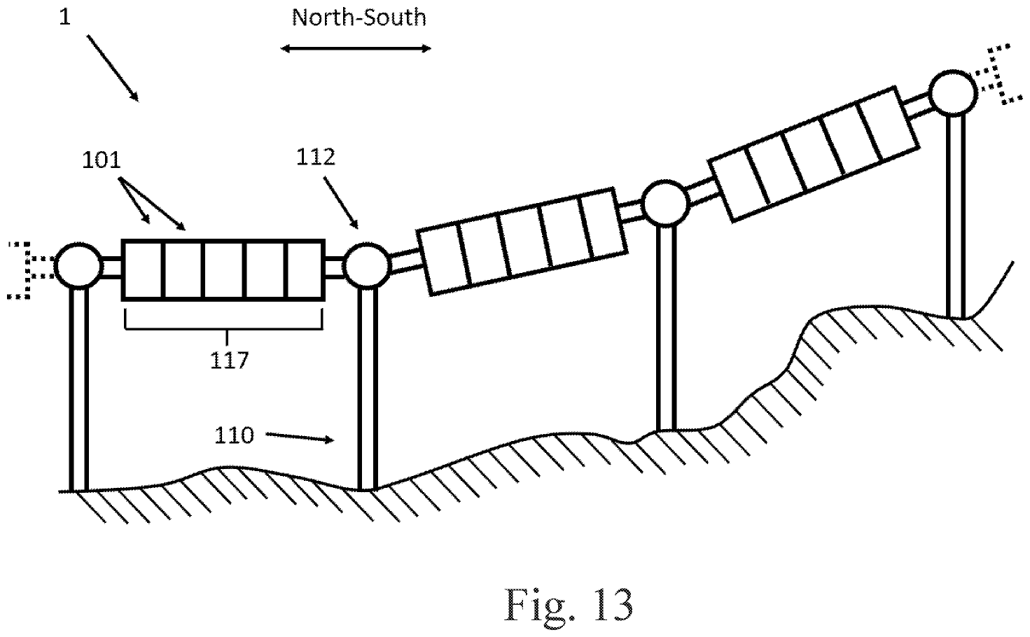

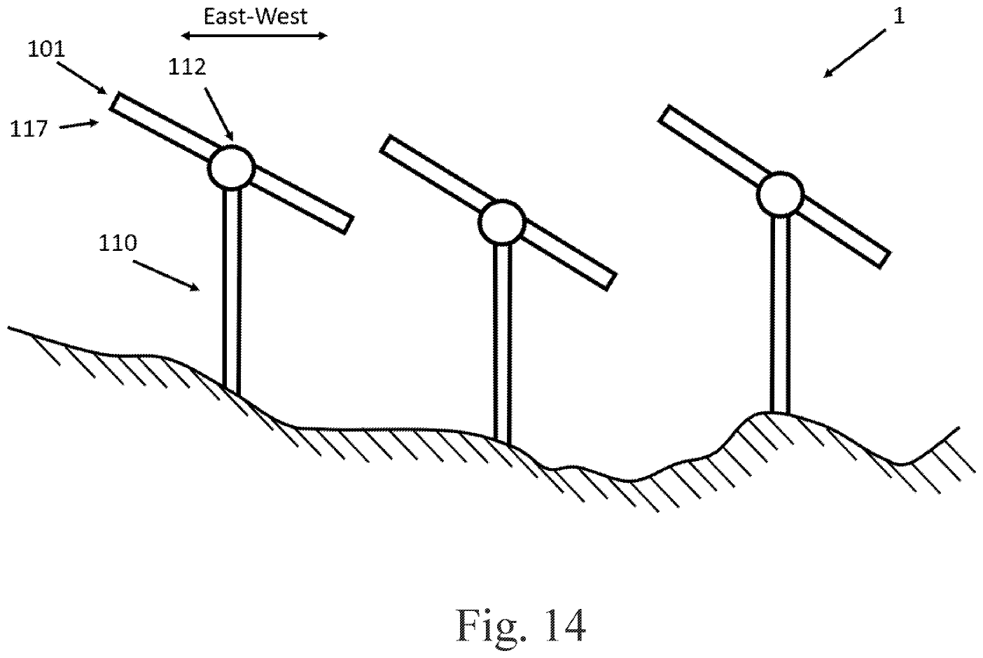

FIGS. 12-14 illustrate a solar array site including multiple trackers. FIG. 12 depicts three trackers in the solar site array directly adjacent to each other, each running along or approximately along the north-south direction with solar modules extending lengthwise in or approximately in the east-west direction. Alternatively, the trackers may run along or approximately along the east-west direction with solar modules extending lengthwise in or approximately in the north-south direction, or any other desired orientation. An angle change is depicted in all three trackers at the bearing assembly 112. The rightmost tracker on the page illustrates that a tracker or a bay 117 in a tracker may a different angle with relationship to the North-South axis than its neighbor(s). Bearing assemblies 112 disposed on a support post 110 could be any of the bearing assemblies described below, such as an articulating bearing assembly. A bay 117 includes a series of solar modules disposed directly adjacent to each other. The bay 117 may be bounded by bearing assemblies 112 and disposed on a single solar panel support 104 (e.g., a torque tube). A single bay 117 may have solar panel modules 101 that have parallel normal vectors and also lie on a same plane as each other, which holds true even as the torque tube rotates the solar modules. The bays 117 in a single tracker and/or across different trackers may have the same number of solar panel modules 101 or different number of solar panel modules 101 as each other, such as from 1 to 20 solar modules, such as from 3 to 15, such as from 5 to 10. The dashed lines at the “ends” of the trackers indicate that there may be more solar panel support 104 and solar panel modules 101 extending in one or either direction, such as more bays. FIG. 13 depicts a cross section of a solar array site looking along the east-west axis, depicting a single tracker with at least three bays 117 for ease of understanding. FIG. 14 depicts a cross section of a solar site array looking along the north-south axis. Three trackers of the solar site array are depicted side by side on the sloped landscape. The solar panel modules 101 in the bays 117 are tilted away from the horizontal. For ease of understanding, only one bay 117 in each of the three trackers is depicted, although in a physical site other bays further down the tracker may be visible from this perspective due to angle changes at the bearing assemblies 112.

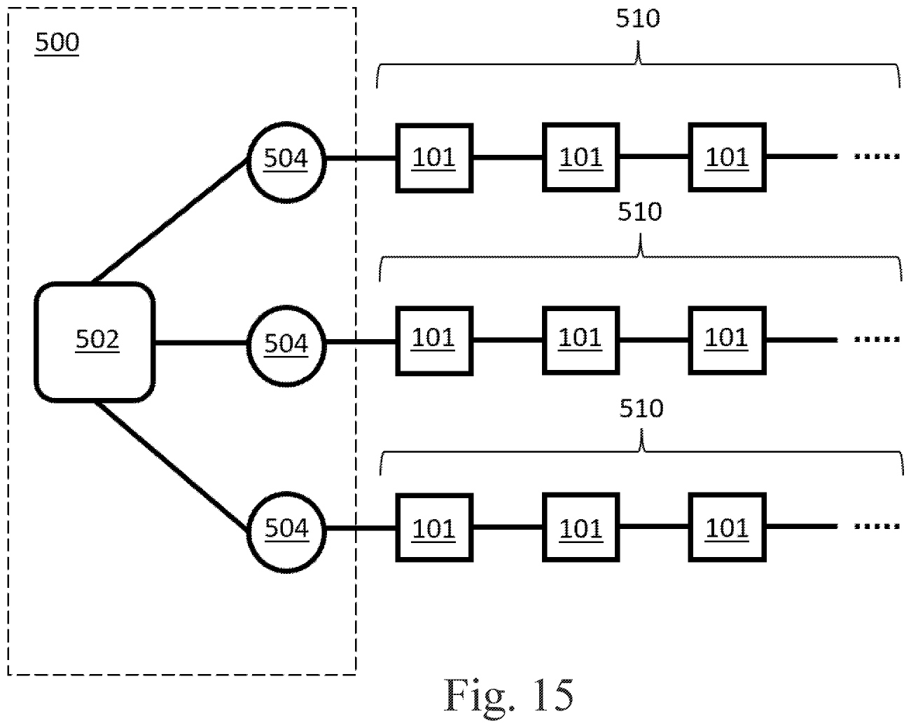

FIG. 15 shows an example of a solar panel array control system 500 coupled to a solar panel array. The solar panel array control system 500 may communicate with the solar panel array. The group control systems 504 may include, be included in, or consist of the controller 410 described above. The solar panel array control system 500 and/or elements of the solar panel array control system 500 (such as the central controller 502 and/or group control systems 504) may include, be included in, or consist of the computer system 620 or elements of the computer system 620 described below.

The solar panel array may include one or more solar panel groups 510 each including one or more solar panel modules 101. The groups 510 may include one or more solar panels connected in series, in parallel, or any combination thereof. The solar panel groups may include rows of solar panels, and may be trackers 100 as described above. Any description herein of rows of solar panels may apply to any other type of arrangement or grouping of solar panels.

Optionally, each group of solar panels may each have (e.g., be coupled to and in communication with) a group control system 504. Each group control system 504 may control operation their respective solar panel group 510. The group control systems 504 may be referred to as row controllers when controlling rows of solar panels. Any number of solar panel groups and/or group control systems may be provided. Each group may comprise any number of solar panels. Each group may have the same number of solar panels or differing numbers of solar panels. A central controller 502 may optionally be provided that may control the group control systems.

The solar panel array control system 500 may comprise the central controller 502 and, optionally, one or more group control systems 504. In some instances, one-way communication may be provided from the central controller to the one or more group control systems. The central controller may send instructions to the one or more group control systems, which may in turn control operation of the corresponding solar panel groups. In some instances, two-way communication may be provided between the central controller and the one or more group control systems. For instance, the group control systems may be group controllers that may send data to the central controller. The central controller may send instructions to the group controllers, for example in response to, or based on, the data received from the group controllers. The data from the one or more group controllers may optionally include data from one or more solar panels, or various types of sensors physically included as part of the solar panel group (e.g., on a torque tube, foundation, bearing assembly, or other part of the tracker), physically remote from the solar panel group, and/or otherwise physically or electrically coupled to the solar panel group.

The solar panel array control system may affect operation of the solar panels, which may include positioning of the solar panels. The control system may affect an orientation of the solar panel. The control system may control amount of rotation, rate of rotation, and/or acceleration of rotation of one or more solar panels. The control system may affect a spatial disposition of the solar panel. The control system may control an amount of translation, speed of translation, and/or acceleration of translation of one or more solar panels. The control system may affect operation of one or more driving mechanisms for a solar panel array, for example the slew drive coupled to one or each of the solar panel groups. The solar panels may be positioned in response to one or more factors, as previously described herein. The solar panel array control system may affect other operations of the solar panels, such as turning the solar panels on or off, operational parameters of converting the solar energy to electrical energy, diagnostics, error detection, calibration, or any other type of operations of the solar panels.

The process and methods described in this specification may be implemented by a hardware computer system. A computer system may include at least one of a processor, memory, non-volatile storage, and an interface. A typical computer system may include at least one or more of the following: a processor, memory, a general-purpose central processing unit (CPU), such as a microprocessor, and/or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software may be stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this description. Even when software is moved to the memory for execution, the processor may make use of hardware registers to store values associated with the software, and local cache that, ideally, serves to speed up execution. A software program may be assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The computer systems can be compatible with or implemented as part of or through a cloud-based computing system. As used in this description, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this description can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this description, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor may transform data into new data using implemented data structures and methods, such as is described with reference to the FIGS. in this description.

The engines described herein, or the engines through which the systems and devices described herein can be implemented, can be cloud-based engines. A cloud-based engine may be an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Datastores may include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. A data structure may be associated with a particular way of storing and organizing data in a computer so that it can be used efficiently within a given context. Data structures may be based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure may entail writing a set of procedures that create and manipulate instances of that structure. The datastores can optionally be cloud-based datastores. A cloud-based datastore may be a datastore that is compatible with cloud-based computing systems and engines.

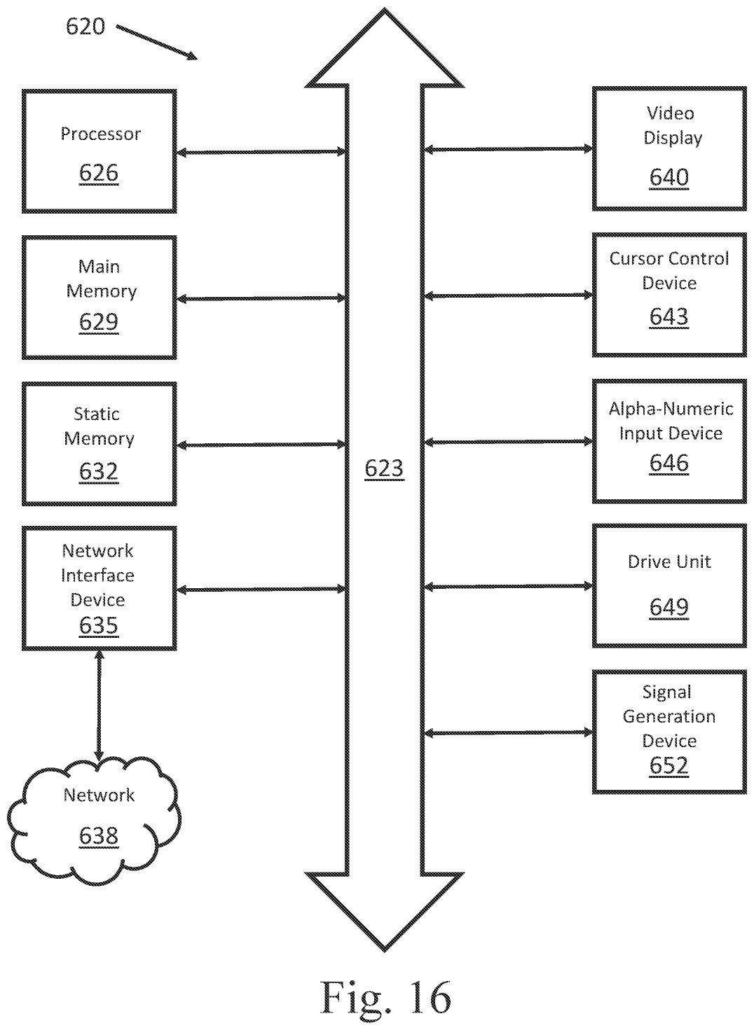

FIG. 16 is a block diagram of a machine in the example form of a computer system 620 within which instructions for causing the machine to perform any one or more of the methodologies discussed herein may be stored and/or executed. The machine may operate as a standalone device or may be connected (e.g., network) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 620 may include a processor 626 (e.g., a central processing unit (CPU), a graphics processing unit (GPU) or both), a main memory 629 and a static memory 632, which communicate with each other via a bus 623. The computer system 620 may further include a video display unit 640 (e.g., a liquid crystal display (LCD) or a cathode ray tube (CRT)). The computer system 220 also includes an alphanumeric input device 646 (e.g., a keyboard), a user interface (UI) navigation (or cursor control) device 643 (e.g., a mouse), a disk drive unit 649, a signal generation device 652 (e.g., a speaker) and a network interface device 635 connected to a network 638.

The disk drive unit 649 (e.g., a hard disk) may include a computer-readable medium on which is stored one or more sets of data structures and instructions (e.g., software and/or algorithms) embodying or utilized by any one or more of the methodologies or functions described herein. The instructions may also reside, completely or at least partially, within the main memory 629 and/or within the processor 626 during execution thereof by the computer system 620, the main memory 629 and the processor 626 also may constitute machine-readable media. The instructions may also reside, completely or at least partially, within the static memory 632.

The term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks. Machine-readable media may also include random access memory (RAM) (such as dynamic RAM (DRAM) and static RAM (SRAM)).

The instructions may further be transmitted or received over a communications network 638 using a transmission medium. The instructions may be transmitted using the network interface device 635 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software. The network interface device 635 may include one or more modems, network interface cards, wireless network interfaces or other interface devices, such as those used for coupling to Ethernet, token ring, or other types of networks.

Embodiments of the computer system may not require every element illustrated in FIG. 16 to be present, such that elements depicted in FIG. 16 may be optional. For example, an embodiment of a computer system used to implement embodiments of the invention may not include a signal generation device 652 or a cursor control device 643.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

This disclosure is illustrative and not limiting. Further modifications will be apparent to one skilled in the art in light of this disclosure and are intended to fall within the scope of the appended claims.

1. A solar tracker, comprising:
a pony module, comprising:
a solar panel, and
a plurality of brackets attached to the solar panel, and
a plurality of support couplers directly attached to the brackets of the pony module;
at least one solar panel module support arranged in the support couplers and configured to support a solar panel module,
a drive device directly attached to the support couplers and configured to rotate the at least one solar panel module support and the pony module,
a controller directly attached to the at least one solar panel module support, and
wherein the solar panel of the pony module is configured to power the controller.

2. The solar tracker of claim 1, wherein the solar panel is configured to power the drive device.

3. The solar tracker of claim 1, wherein the solar panel is bifacial.

4. The solar tracker of claim 1, further comprising a plurality of solar panel modules disposed on the at least one solar panel module support, and
wherein the solar panel of the pony module is on a parallel plane with planes of the solar panel modules.

5. The solar tracker of claim 1, wherein the support couplers are each a cradle comprising wings angled at a non-perpendicular angle to a surface of the drive device attached to the cradle,
the brackets comprise a surface attached to the wings parallel to a plane of the wings.

6. The solar tracker of claim 1, wherein the plurality of support couplers comprise two support couplers on opposing sides of the drive device,
and the plurality of brackets comprise two brackets directly attached to the two support couplers, respectively.

7. The solar tracker of claim 1, wherein the pony module is not in direct contact with the drive device.

8. A solar tracker, comprising:
a pony module, comprising:
a solar panel, and
a plurality of brackets attached to the solar panel, and
a drive device directly attached to the brackets of the pony module,
a plurality of support couplers coupled to the drive device,
at least one solar panel module support arranged in the support couplers and configured to support a solar panel module,
a controller directly attached to the at least one solar panel module support, and
wherein the solar panel of the pony module is configured to power the controller and the drive device is configured to rotate the at least one solar panel module support and the pony module.

9. The solar tracker of claim 8, wherein the solar panel is configured to power the drive device.

10. The solar tracker of claim 8, wherein the solar panel is bifacial.

11. The solar tracker of claim 8, further comprising a plurality of solar panel modules on the at least one solar panel module support,
wherein the solar panel of the pony module is on a parallel plane with planes of the solar panel modules.

12. The solar tracker of claim 8, wherein one of the brackets comprises a plate with first holes,
the support coupler comprises second holes aligned with the first holes,
the drive device includes third holes aligned with the first holes and the second holes, and
a plurality of fasteners being arranged through the first holes, the second holes, and the third holes.

13. The solar tracker of claim 8, wherein the brackets are spaced apart from each other at a distance lesser than a width of the drive device, the width taken in a direction perpendicular to a surface of the drive device attached with one of the brackets.

14. The solar tracker of claim 8, further comprising a plurality of solar panel modules disposed on the at least one solar panel module support,
wherein the solar panel of the pony module has a smaller area than each of the solar panel modules.

15. A solar panel assembly, comprising:
a pony module, comprising:
a solar panel,
a controller directly attached to the solar panel, and
a plurality of brackets attached to the solar panel, and
a drive device directly attached to the brackets of the pony module, and
a plurality of support couplers coupled to the drive device and configured to couple at least one solar panel module support to the drive device, and
wherein the solar panel of the pony module is configured to power the controller and the drive device is configured to rotate the at least one solar panel module support and the pony module.

16. The solar tracker of claim 15, wherein the solar panel powers the drive device

17. The solar tracker of claim 15, further comprising a plurality of solar panel modules on the at least one solar panel module support, and the solar panel of the pony module is on a parallel plane with planes of the solar panel modules.

18. The solar tracker of claim 15, wherein one of the brackets comprises a plate with first holes,
the support coupler comprises second holes aligned with the first holes,
the drive device includes third holes aligned with the first holes and the second holes, and
a plurality of fasteners being arranged through the first holes, the second holes, and the third holes.

19. The solar tracker of claim 15, wherein the brackets are spaced apart from each other at a distance lesser than a width of the drive device, the width taken in a direction perpendicular to a surface of the drive device attached with one of the brackets.

20. The solar tracker of claim 15, further comprising a plurality of solar panel modules disposed on the at least one solar panel module support,
wherein the solar panel of the pony module has a smaller area than each of the solar panel modules.
